(19) United States
(12) Patent Application Publication
(10) Pub. No.: US 2019/0056854 A1
(43) Pub. Date: Feb. 21, 2019

(54) DEVELOPING A NON-RECTANGULAR USER INTERFACE

(71) Applicant: HEWLETT-PACKARD DEVELOPMENT COMPANY, L.P., Houston, TX (US)

(72) Inventors: Deny AZZOLIN, Vancouver, WA (US); Karine PERALTA, Porto Alegre (BR); Bruno DAL BO, Vancouver, WA (US)

(73) Assignee: Hewlett-Packard Development Company, L.P., Houston, TX (US)

(21) Appl. No.: 16/078,471

(22) PCT Filed: Oct. 31, 2016
(86) PCT No.: PCT/US2016/059733

§ 371 Date: Aug. 21, 2018

(51) Int. Cl. G06F 3/0484; G06F 3/0482

(52) U.S. Cl. CPC G06F 3/04845; G06F 3/0482

(57) ABSTRACT

A development system for developing a non-rectangular user interface includes a geometry tool to convert coordinates between a rectangular coordinate system and a non-rectangular coordinate system suitable for the non-rectangular user interface. The development system includes an area segmentation tool to facilitate segmenting the non-rectangular user interface into segmented areas based on the non-rectangular coordinate system. The development system includes a content warping tool to facilitate warping content designed for display on a rectangular user interface into content that is based on the non-rectangular coordinate system and that conforms to the segmented areas of the non-rectangular user interface.

### BACKGROUND

The reach and scope of computing devices grew immensely in the past few years with the introduction of smartphones and tablets, and is now on the brink of further growth with the Internet of Things (IoT) and wearable computing devices. The growing availability of smart watches, connected thermostats, sensors and actuators, car dashboards, wrist bands and other devices brings up a noticeable attribute: these devices rely on a myriad of shapes with displays used to convey information and propose human interactions that often diverge from the usual rectangular ones the industry has been relying on for so many years. Most notably, the devices may often have circled, elliptical or “squircle” (i.e., rounded box) geometries, where the traditional, orthogonal user interface construction techniques are a misfit. Despite the unusual shape and size of such displays, users do not expect less quality or less visual impact than displays they rely on today on smartphones and desktops computers. More than that, the success of such devices as products and solutions may rely even more on high-quality user experiences, since users may face a learning curve.

### BRIEF DESCRIPTION OF THE DRAWINGS

FIG. 1 is a block diagram illustrating one example of a development system for developing a non-rectangular user interface.

FIG. 2 is a diagram illustrating four examples of warping performed by a content warping tool.

FIG. 3 is a diagram illustrating three examples of area segmentation by chords performed by an area segmentation tool.

FIG. 4 is a diagram illustrating three examples of area segmentation by slices performed by an area segmentation tool.

FIG. 5 is a diagram illustrating area segmentation by compositions performed by an area segmentation tool.

FIG. 6 is a diagram illustrating three examples of coordinate systems that may be used by the development system shown in FIG. 1.

FIG. 7 is a flow diagram illustrating a method for developing a non-rectangular user interface according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

The rising popularity of smart and wearable devices is pushing the industry to broadly experiment both on use cases and form factors, bringing to users applications with novel compelling user interfaces built on top of displays that diverge from the traditional rectangular ones. Smart watches, car or thermostat dashboards, as well as other devices are relying on non-rectangular displays (e.g., lines, ellipses, circles, triangles, etc.), where the current user interface construction techniques and underlying geometries are a misfit, leading to complex and costly workarounds.

User interface (UI) frameworks may rely on an orthogonal geometry that enables both placement (e.g., where to place a particular point or component) and layout (e.g., how to distribute the area or how components relate to each other) on top of a rectangular (e.g., square) space, with top, left, width, and height coordinates. From desktops to mobile devices or web-delivered UI, the frameworks may establish that the base screen is rectangular, and the abstractions of visual components may be built on top of the rectangular space.

From layout management, alignment and animations to collections of user controls and interactions, most developer tools or practices conform to or directly derive from the traditional width and height, boxed toolset and frameworks. That turns the design and development of user interfaces for round or other non-rectangular displays into a complex and costly exercise of placement workarounds, custom development of controls, and adaptation of shapes and behaviors, with a great deal of planning and rework.

When building a user interface that is not square (e.g., a watch face where numbers and labels are distributed along a circle, and watch hands rotate using the center of the circle as the starting point), some techniques may involve the developer mixing and matching, and mapping the source coordinates to adapt to the round area. Some techniques may involve providing rotations and scaling about a pivot point, applying affine transforms, and cutting and composing images or shapes in order to simulate a conformance of shapes to the circular area (e.g., “distorted buttons” that may conform to the border of the circle). However, techniques that combine visual and behavioral primitives, such as user controls (e.g., buttons, frames, lists, etc.) on a partitioned square area with regular orthogonal (x, y, width, height) coordinate systems, may be inefficient when applied to a non-rectangular area. This adds complexity and time to develop and test, and can also lead to applications that visually do not take advantage of, or do not get “aware” of, the display.

Examples disclosed herein provide a backing geometry and an accompanying toolset to allow designers and developers to easily create compelling non-rectangular user interfaces while taking full advantage of non-rectangular displays. Some examples disclosed herein are directed to a UI framework for producing a non-rectangular (e.g., round or circle-shaped) application user interface for a non-rectangular display. Some examples disclosed herein may use image processing methods that can bend or warp images, and math tools such as affine transformations that handle placement and rotation of vector or pixel shapes. Some of those techniques may be present in graphics environments (such as GPU shaders, openGL, etc.), and end-user applications. Some examples disclosed herein combine these techniques in such a way that addresses content conformation to a particular non-rectangular area shape in a parameterized manner.

Some examples disclosed herein use three sets of techniques or tools, which are a geometry tool, and area segmentation tool, and a content warping tool. The geometry tool introduces a new underlying geometry based on polar coordinates to address, for example, circular displays (e.g., using angle and radius from the center of the circle) along with an edge anchoring to facilitate placement (e.g., north, south, northeast, etc.) and a hierarchical visual tree (e.g., components are a child to other components, inheriting rotation, radiuses, etc.).

The area segmentation tool uses techniques that are a best fit for round areas, such as straight chords (i.e., a line that cuts the circle in two areas, defined by a radius and angle), slices (e.g., like in a pie chart, defined by percentages) and curved chords that use the intersection of the circular display area with another circle, dividing the target circle into two areas.

The content warping tool “conforms” content that is originally defined in the square space, such as text, images, boxes, shapes, etc., to the round area, in any particular position from the center, using the anchor edges, angles and radius. The content warping tool makes the best usage of the round area, and turns UI development into an easier task. It is noted that these tools may be applied to different shapes other than circles (e.g., triangles and ellipses). For each different user interface shape, the tools use the best geometry, area segmentation, and warping techniques for that shape.

Designing a user interface may involve employing completely abstract disciplines and attributes such as spatial perception, metaphor constructions, correlation and organization of data and perceived tasks, and a highly refined quality perception. While highly abstract, there is method in this process, and designers may perceive user interfaces as “dynamic canvases”, where visual constructions are not static and perpetual, but change shape, style, position and meaning over time. Therefore, a designer may map the building of a user interface to a “timeline” where the designer defines a stage by partitioning the canvas space and laying out places and areas over time, and also identifies actors and scripts that those actors may play over time. Such actors may be identified as components with their intrinsic behaviors, their visual appearance and the scripts as the response to events and actions and the actual semantic or data that an actor is to convey or display.

Some examples disclosed herein introduce a new form of canvas. While comfortable and natural from a human perspective, the canvas involves new rules for a stage definition, and also new actors. Considerations for this framework included the following: (1) How a developer can partition a non-rectangular canvas in such ways (e.g., using a pie chart partitioning) that it feels natural and visually compelling considering the non-rectangular shape, and in a simple and intuitive fashion, without requiring the developer to use a complex mathematical description; (2) what is the visual behavior of common actors when placed inside the round canvas (e.g., boxes, lines, text, simple shapes), so the influence of the canvas on them can be easily understood; and (3) what is the set of actors and scripts that compose a minimum collection that designers can rely on to, by composition, achieve the desired UI visuals and behaviors.

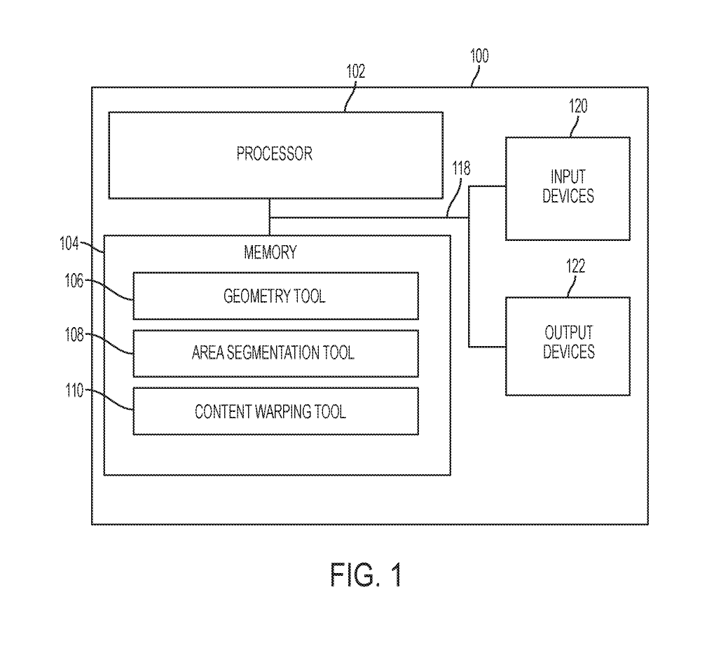

FIG. 1 is a block diagram illustrating one example of a development system 100 for developing a non-rectangular user interface. Development system 100 provides a UI framework including a backing geometry and an accompanying toolset to allow designers and developers to easily create compelling user interfaces for non-rectangular displays. The development system 100 provides a coherent mechanism for designers to produce layouts of visuals and define behaviors of components without having to give up on their traditional tools and skill set. The development system 100 allows developers to develop user interfaces for non-rectangular displays without requiring the developers to learn a new coordinate system, or acquire proficiency in specific math equations or calculations.

Development system 100 includes at least one processor 102, a memory 104, input devices 120, and output devices 122. Processor 102, memory 104, input devices 120, and output devices 122 are communicatively coupled to each other through communication link 118 (e.g., a bus).

Processor 102 includes a Central Processing Unit (CPU) or another suitable processor. In one example, memory 104 stores machine readable instructions executed by processor 102 for operating development system 100. Memory 104 includes any suitable combination of volatile and/or non-volatile memory, such as combinations of Random Access Memory (RAM), Read-Only Memory (ROM), flash memory, and/or other suitable memory. These are examples of non-transitory computer readable media. The memory 104 is non-transitory in the sense that it does not encompass a transitory signal but instead is made up of at least one memory component to store machine executable instructions for performing techniques described herein.

Memory 104 stores geometry tool or module 106, area segmentation tool or module 108, and content warping tool or module 110. Processor 102 executes instructions of geometry tool 106 to provide an underlying geometry based on polar coordinates to address non-rectangular displays, including edge anchoring to facilitate placement of UI elements and a hierarchical visual tree. Processor 102 executes instructions of area segmentation tool 108 to segment the user interface display area using techniques that are a best fit for non-rectangular areas, such as straight chords, slices, and curved chords. Processor 102 executes instructions of content warping tool 110 to warp content that is originally defined in a rectangular or square space to conform to a non-rectangular area.

Input devices 120 include a keyboard, mouse, data ports, and/or other suitable devices for inputting information into development system 100. Output devices 122 include a monitor, speakers, data ports, and/or other suitable devices for outputting information from development system 100.

Geometry tool 106 provides a backing geometry to allow a user to accomplish a visual user interface layout for a non-rectangular display. The geometry tool 106 provides a smooth transition from rectangular coordinates to polar coordinates and vice-versa, for placements and primitive operations. Based on the geometrical rule set, concrete visual and behavioral façades are presented and act as design-ready components that hide the underlying mathematics from the developer without compromising the framework's potential.

Regarding the backing geometry, primitive elements are defined, including a rectangle element and an elliptical element. In a round display, the elliptical element is the root of the visual tree. The rectangle element is defined in a plane by four values (x, y, width, height), where x and y are coordinates of the rectangle element, width is the width of the rectangle element, and height is the height of the rectangle element. The elliptical element is defined by four values as well (xc, yc, R, r), where xc and yc are x and y coordinates of the center of the elliptical element, R is the major axis length, and r is the minor axis length. A circle is an ellipse where R=r.

Relative positioning (anchoring) can be achieved with an augmented set of geometrical rules pertinent to ellipses. First, an orthodox “center anchor” is defined, which aligns shapes to their geometrical centers. Furthermore, an “edge anchor” forces edge x of primitive A to be in the same place as edge y of primitive B. In rectangles, there are four possible edges, while in ellipses there are infinite edges. Therefore, edge anchoring specifies an incidence angle. Edge anchoring may be implemented for any ellipse-rectangle combination.

Merely gluing edges together may not be aesthetically pleasing. Thus, anchoring may be accompanied by margins, which define a minimum space between components. As with edge anchors for a rectangle, there are also four margins for a rectangle. In one example, edge margins for an ellipse are simplified to a set of four: North (N), South (S), West (W), and East (E). The four margin values define a composition of two auxiliary ellipses described by (xc,yc,R+[N,W],r+[W,N]) and (xc,yc,R+[S,E],r+[s,e]), which define the Boolean union of two ellipses with modified major and minor axes according to the specified margin values. This allows for complex geometrical placement using a simple notation.

Another relative organizational behavior, referred to herein as an “Atom”, is also used in some examples. Atoms use the center of gravity and margin definitions to place their children from the center. The first child is placed at the center and the next children are laid out around it, obeying the margin restrictions and optimizing for maximum symmetry along a specified axis.

Area segmentation tool 108 uses second-degree primitives, such as chords and slices. Chords are straight or curved lines that cross the non-rectangular geometry, dividing its area in two parts called segments, allowing for the organization of visually compelling interfaces through coherent segmentation of the curved area.

Content warping tool 110 includes a math toolset to promote bending, warping and scaling of content to be displayed. An ellipse's periphery allows larger drawing areas than the center. By defining a method to allow a user to draw around the periphery, content warping tool 110 gives users the power to employ more area, without using cropping tricks or complex mathematics. This task is accomplished with a warping technique. Any rectangle primitive that is a child to an ellipse primitive can be warped to its parent's curvature. For example, to draw a warped box around the bottom edge of the screen, a rectangle may be defined that anchors to the South edge. Then, with inherited warping, the box warps and becomes a segmented sector.

Text may also be warped by content warping tool 110 by slightly adjusting each letter rotation to follow the rectangle's warped coordinate system. Warping may be defined as geometrical or pixel-based. Geometrical warping is used for text in some examples, since it avoids distortion of the actual drawing of the letters, and only their individual rotations are changed. The box's border may be warped on a pixel-basis into a rounded shape. A picture may be warped either way depending on the application. Warped components around the edges may define an inherent floating Cartesian coordinate system anchored to their leftmost-topmost corner to assure that the user interface does not fall into an unusable state, like text being drawn upside-down.

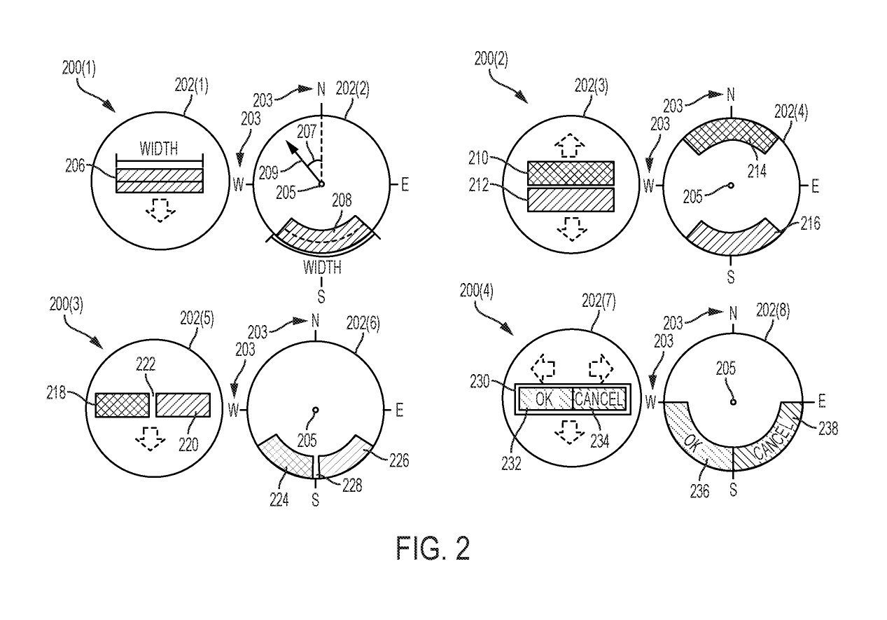

FIG. 2 is a diagram illustrating four examples 200(1)-200(4) of warping performed by the content warping tool 110. In example 200(1), circular display 202(1) is displaying a rectangular user interface element 206, and circular display 202(2) is displaying a warped version 208 of the user interface element 206. The circular display 202(2) includes four edge anchors 203 (i.e., North (N), South (S), East (E), and West (W)) and a center anchor 205, which are used to define orientation. An incidence angle 207 and a radius 209 (e.g., radial distance away from center anchor 205) provide polar coordinates for defining placement of elements within the circular display 202(2). Warping conforms a boxed shape element or a text box element to the circular display area, given an angle 207 and radius 209 for that element.

To create the warped version 208, the content warping tool 110 warps the user interface element 206 to include two curved edges (i.e., top and bottom edges) with a curvature that matches the curvature of the circular display 202(1)/202(2), and shifts the user interface element 206 downward to a bottom periphery of the display 202(2). The curved bottom edge of the warped version 208 is anchored to the bottom (i.e., South (S) edge anchor 203) of the display 202(2). The width of the warped version 208 may be the same as the width of the original element 206, or the width of the warped version 208 may be made larger or smaller than the original element 206.

In example 200(2), circular display 202(3) is displaying vertically aligned rectangular user interface elements 210 and 212, and circular display 202(4) is displaying warped versions 214 and 216 of the user interface elements 210 and 212, respectively. To create the warped versions 214 and 216, the content warping tool 110 warps each of the user interface elements 210 and 212 to include two curved edges (i.e., top and bottom edges) with a curvature that matches the curvature of the circular display 202(3)/202(4). The content warping tool 110 also shifts the user interface element 210 upward to a top periphery of the display 202(4), and shifts the user interface element 212 downward to a bottom periphery of the display 202(4). The curved top edge of the warped version 214 is anchored to the top (i.e., North (N) edge anchor 203) of the display 202(4), and the curved bottom edge of the warped version 216 is anchored to the bottom (i.e., South (S) edge anchor 203) of the display 202(4).

In example 200(3), circular display 202(5) is displaying horizontally aligned rectangular user interface elements 218 and 220, and circular display 202(6) is displaying warped versions 224 and 226 of the user interface elements 218 and 220, respectively. There is a space or padding 222 between the user interface elements 218 and 222, and a corresponding space or padding 228 between the warped versions 224 and 226. To create the warped versions 224 and 226, the content warping tool 110 warps each of the user interface elements 218 and 220 to include two curved edges (i.e., top and bottom edges) with a curvature that matches the curvature of the circular display 202(5)/202(6). The content warping tool 110 also shifts the user interface elements 218 and 220 downward to a bottom periphery of the display 202(6). The curved bottom edges of the warped versions 224 and 226 are anchored to the bottom (i.e., South (S) edge anchor 203) of the display 202(6).

In example 200(4), circular display 202(7) is displaying horizontally aligned rectangular user interface elements 232 and 234, which are positioned together as a stack 230 without any spacing between the elements, and circular display 202(8) is displaying warped versions 236 and 238 of the user interface elements 232 and 234, respectively. User interface element 232 includes text (i.e., “OK”) positioned within the element 232, and user interface element 234 includes text (i.e., “Cancel”) positioned within the element 234. To create the warped versions 236 and 238, the content warping tool 110 warps each of the user interface elements 232 and 234 to include two curved edges (i.e., top and bottom edges) with a curvature that matches the curvature of the circular display 202(7)/202(8). The content warping tool 110 also shifts the user interface elements 232 and 234 downward to a bottom periphery of the display 202(8). The curved bottom edges of the warped versions 236 and 238 are anchored to the bottom (i.e., South (S) edge anchor 203) of the display 202(8). The text contained in the user interface elements 232 and 234 is warped by content warping tool 110 by adjusting the rotation of each letter to follow the warped coordinate system and curvature of the warped versions 236 and 238.

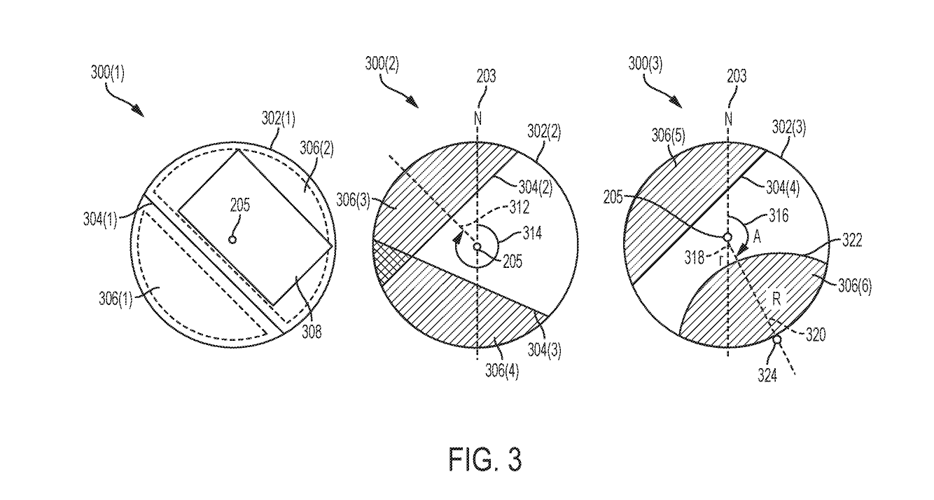

FIG. 3 is a diagram illustrating three examples 300(1)-300(3) of area segmentation by chords performed by the area segmentation tool 108. In example 300(1), circular display 302(1) is divided into two segments 306(1) and 306(2) by straight chord 304(1). The two segments 306(1) and 306(2) are individually addressable and share a center anchor 205 of the original circular display area. Straight chords, such as straight chord 304(1), can behave as either a smart rectangle or as a masked ellipse. As shown in FIG. 3, a rectangle 308 is positioned completely within segment 306(2).

In example 300(2), circular display 302(2) is divided into multiple segments, including segments 306(3) and 306(4), by straight chords 304(2) and 304(3). Straight chords 304(2) and 304(3) intersect at a point within the interior of the circular display 302(2), and the segments 306(3) and 306(4) include a region of overlap. Straight chords, such as straight chords 304(2) and 304(3), are defined by a chord angle 314 against an anchor and a chord radius 312 that is the perpendicular distance of the chord edge from the center anchor 205.

In example 300(3), circular display 302(3) is divided into multiple segments, including segments 306(5) and 306(6), by straight chord 304(4) and curved chord 322. The use of curved chords can provide for smoother area splitting. For curved chords that are used as masked ellipses, a principal is chosen that defines its center and warping behavior. Curved chords are defined by an angle (A) 316 against an anchor, a chord radius (r) 318 that is the perpendicular distance of the chord edge from the center anchor 205, and a distance (R) 320 from the center anchor 205 to the center 324 of another circle, which radius is defined by (R-r) and defines the radius of curvature of the curved chord 322.

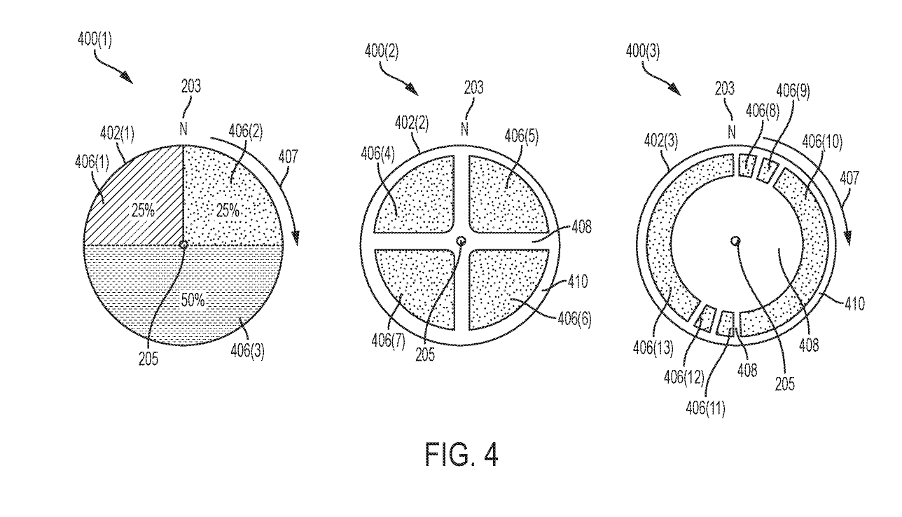

Slices are a natural form of segmentation of a round display area, splitting it in a defined number of arcs using a round center as an anchor. FIG. 4 is a diagram illustrating three examples 400(1)-400(3) of area segmentation by slices performed by the area segmentation tool 108. In example 400(1), circular display 402(1) is divided into three slices 406(1)-406(3). In the illustrated example, the slices completely cover the display area, and the division of the slices is made using proportions (e.g., slices 406(1) and 406(2) each occupy 25% of the display area, and slice 406(3) occupies 50% of the display area). The division of the slices may also be made using the center anchor 205 and angle subdivisions, starting from a defined edge anchor (e.g., North (N) edge anchor 203) and defining angles for each slice, such as angle 407. Stricter sizing may also be used, considering for instance the available size on an inner rectangle of the resulting slice, length of the slice outer arc, or angle span (start/end). Proportions or angles are defined from a starting edge anchor 203 and divide the display area according to values (e.g., percentage values or angle values). Slice angles may be defined by façades that free designers and developers from calculating angles, such as percentages with wildcards and number of repeated slices.

In example 400(2), circular display 402(2) is divided into four slices 406(4)-406(7). A margin 410 is provided between the outer periphery of the display 402(2) and the outer edges of the slices 406(4)-406(7), and a space or padding 408 is provided between each adjacent slice, so the slices 406(4)-406(7) do not completely cover the available display area. The padding 408 and margin 410, both for resulting edges and the center, provide a rich alternative to produce a more complex segmentation.

In example 400(3), circular display 402(3) is divided into six slices 406(8)-406(13). A margin 410 is provided between the outer periphery of the display 402(3) and the outer edges of the slices 406(8)-406(13), and space or padding 408 is provided in a central region of the display area as well as between each adjacent slice, so the slices 406(8)-406(13) do not completely cover the available display area. The sizes of the slices 406(8)-406(13) are defined in part by corresponding angle values, such as 15, 15, 150, 15, 15, and 150, respectively.

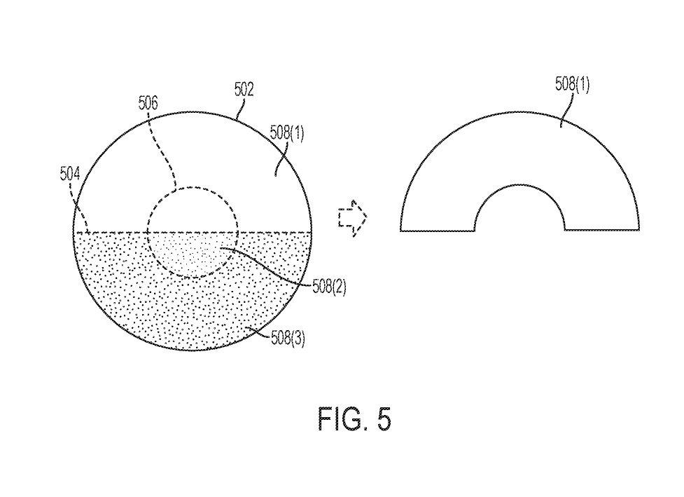

FIG. 5 is a diagram illustrating area segmentation by compositions performed by the area segmentation tool 108. Circular display 502 is divided into multiple segments, including segments 508(1)-508(3), by straight chord 504 and curved chord 506. A composition, as used herein, relies on Boolean operations combining the shape of the canvas or display area with proposed partitioning (e.g., either slices or chords), and results in another basic canvas with limited, pre-defined segments. For example, as shown in FIG. 5, segments 508(2) and 508(3) may be removed, resulting in a user interface that includes a single segment 508(1). Compositions are useful to address specific display shapes, particularly those that involve some masking such as car dashboards.

Classical components that are children to ellipse primitives can define classical Cartesian coordinates, aligned with the center or with an anchor such as North or 0,0 of the underlying pixel matrix. This may be accomplished by defining smart rectangles that allow transparent fallback to the usual coordinate system. Inner and outer rectangles are defined as the largest rectangles contained by and containing the geometry, respectively. Single-pivot rectangles define a width/height constraint; the other value is calculated for the largest resulting area.

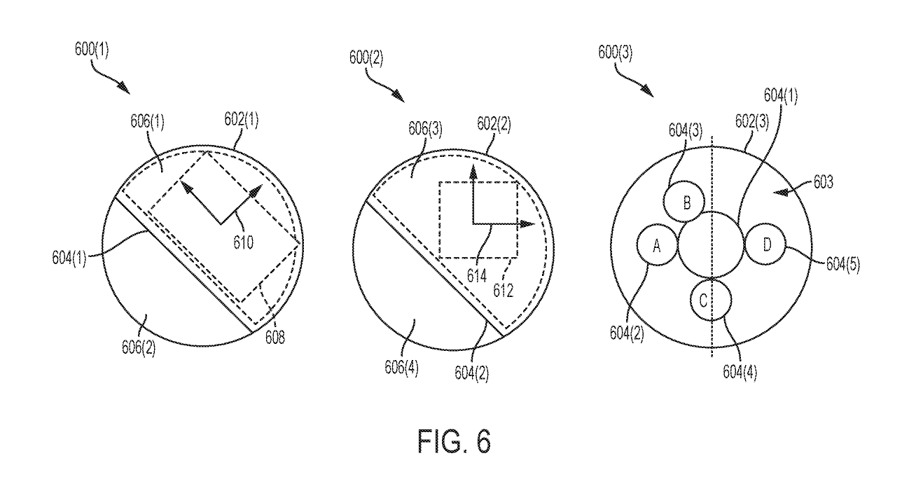

FIG. 6 is a diagram illustrating three examples 600(1)-600(3) of coordinate systems that may be used by the development system 100 shown in FIG. 1. In example 600(1), circular display 602(1) is divided into two segments 606(1) and 606(2) by straight chord 604(1). A rectangle 608 is positioned completely within segment 606(1). Coordinate system 610 is a radial coordinate system that is aligned with the center and radius of the circular display 602(1). In example 600(2), circular display 602(2) is divided into two segments 606(3) and 606(4) by straight chord 604(2). A rectangle (e.g., square) 612 is positioned completely within segment 606(3). Coordinate system 614 is anchored relative to a North direction of the circular display 602(2). In example 600(3), an atom 603 that uses an atom coordinate system is illustrated. The atom 603 includes children elements 604(1)-604(5). The atom 603 uses center of gravity and margin definitions to place the children elements from the center. The first child element 604(1) is placed at the center, and the remaining children elements 604(2)-604(5) (with text labels A, B, C, and D, respectively) are laid out around the child element 604(1). The children elements 604(2)-604(5) appear to “gravitate” around the child element 604(1). Although the children elements 604(2)-604(5) are shown in contact with the child element 604(1) in the illustrated example, in other examples the children elements may be defined to have a certain amount of space or padding surrounding the elements to provide separation between each element. In some examples, an atom, such as atom 603, places components around a primitive center respecting a parameterized gravitational pull and both elliptical margin and anchoring definitions.

The set of geometrical rules and concepts described herein may be applied to build a base set of organizational components. Ellipses and rectangles are primitive components that implement basic drawing capabilities (e.g., users are able to draw their defining primitive shapes with stroke, fill, color and transparency properties). The primitive components may also contain children relatively positioned inside them. Some examples disclosed herein use two organizational components: rectangular stacks and grids. Stacks lay out their children in a line (either vertical or horizontal), and grids lay out their children in rows and columns. An “atom” may be defined as a component itself, which follows the aforementioned rules for child placement. Also, leaf event-powered components such as text labels, text fields and picture boxes may be included.

In some examples, the functionality of the set of controls may be augmented by the underlying geometry. Warping is one tool to achieve this behavior. Warping a component may be applied when the immediate parent of the component is either an ellipse or is warped itself. Warping may be toggled along the visual tree. That is, a pixel-warped parent can have geometry-warped children. By warping a stack, the effect illustrated in FIG. 2 can be achieved. Components follow the defined inner coordinate system. For example, for a warped stack container anchored to the South edge containing children A and B, where A is the leftmost child, child A will still be to the left when the stack is anchored to the North edge. This self-correcting feature provides development speed and predictability to the base layout engine.

Relative positioning ellipse “edges” may involve the choice of an incidence angle. Angles can be specified in degrees (e.g., counterclockwise, starting from the leftmost corner, as of a polar coordinates convention) or by using a system based on a compass rose: E (East, 0 degrees), N (North, 90 degrees), W (West, 180 degrees) and S (South, 270 degrees). This system can be used to easily compose angles in a straightforward string of characters, such as SW (Southwest, 225 degrees) or even NNE (North-northeast, 67.5 degrees).

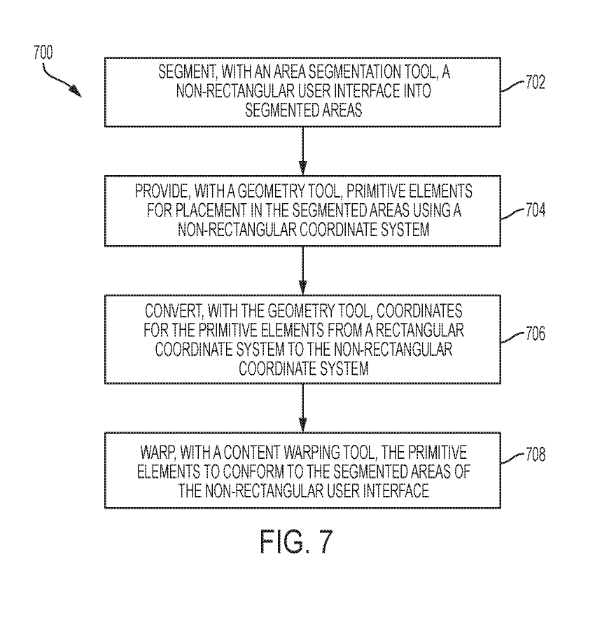

FIG. 7 is a flow diagram illustrating a method 700 for developing a non-rectangular user interface according to one example. In one example, development system 100 (FIG. 1) is configured to perform method 700. At 702, the method 700 segments, with an area segmentation tool, the non-rectangular user interface into segmented areas. At 704, the method 700 provides, with a geometry tool, primitive elements for placement in the segmented areas using a non-rectangular coordinate system. At 706, the method 700 converts, with the geometry tool, coordinates for the primitive elements from a rectangular coordinate system to the non-rectangular coordinate system. At 708, the method 700 warps, with a content warping tool, the primitive elements to conform to the segmented areas of the non-rectangular user interface.

One example is directed to a development system for developing a non-rectangular user interface. The development system includes a geometry tool to convert coordinates between a rectangular coordinate system and a non-rectangular coordinate system suitable for the non-rectangular user interface. The development system includes an area segmentation tool to facilitate segmenting the non-rectangular user interface into segmented areas based on the non-rectangular coordinate system. The development system includes a content warping tool to facilitate warping content designed for display on a rectangular user interface into content that is based on the non-rectangular coordinate system and that conforms to the segmented areas of the non-rectangular user interface.

The non-rectangular user interface may be an elliptical-shaped user interface. The non-rectangular user interface may be a circular-shaped user interface. The non-rectangular coordinate system may be a polar coordinate system. The area segmentation tool may allow a user to segment the circular-shaped user interface into the segmented areas with straight chords, curved chords, and slices. The geometry tool may provide primitive elements for placement in the non-rectangular user interface, including at least a rectangle element and an elliptical element. The geometry tool may allow a user to define an atom that automatically positions a first one of the primitive elements in a center position of the user interface with other ones of the primitive elements surrounding the first primitive element while respecting a parameterized gravitational pull and margin and anchoring definitions for the primitive elements. The geometry tool may allow a user to define edge anchors for anchoring the primitive elements within the non-rectangular user interface, including at least a North edge anchor, a South edge anchor, an East edge anchor, and a West edge anchor. The geometry tool may allow a user to specify a margin for each of the primitive elements, wherein the margin defines a minimum spacing between the primitive elements.

Another example is directed to a method for developing a non-rectangular user interface. The method includes segmenting, with an area segmentation tool, the non-rectangular user interface into segmented areas. The method includes providing, with a geometry tool, primitive elements for placement in the segmented areas using a non-rectangular coordinate system. The method includes converting, with the geometry tool, coordinates for the primitive elements from a rectangular coordinate system to the non-rectangular coordinate system. The method includes warping, with a content warping tool, the primitive elements to conform to the segmented areas of the non-rectangular user interface.

The non-rectangular user interface may be an elliptical-shaped user interface. The non-rectangular coordinate system may be a polar coordinate system. The area segmentation tool may allow a user to segment the non-rectangular user interface into the segmented areas with straight chords, curved chords, and slices.

Yet another example is directed to a non-transitory computer-readable storage medium storing instructions that, when executed by at least one processor, cause the at least one processor to: segment an elliptical user interface into segmented areas; warp primitive user interface elements to conform to the segmented areas of the elliptical user interface; convert coordinates for the primitive user interface elements from a rectangular coordinate system to a polar coordinate system; and position the warped primitive user interface elements in the segmented areas using the polar coordinate system.

The non-transitory computer-readable storage may also store instructions that, when executed by the at least one processor, further cause the at least one processor to: anchor an edge of at least one of the primitive user interface elements to an edge of the elliptical user interface.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A development system for developing a non-rectangular user interface, comprising:
a geometry tool to convert coordinates between a rectangular coordinate system and a non-rectangular coordinate system suitable for the non-rectangular user interface;
an area segmentation tool to facilitate segmenting the non-rectangular user interface into segmented areas based on the non-rectangular coordinate system; and
a content warping tool to facilitate warping content designed for display on a rectangular user interface into content that is based on the non-rectangular coordinate system and that conforms to the segmented areas of the non-rectangular user interface.

2. The development system of claim 1, wherein the non-rectangular user interface is an elliptical-shaped user interface.

3. The development system of claim 1, wherein the non-rectangular user interface is a circular-shaped user interface.

4. The development system of claim 3, wherein the non-rectangular coordinate system is a polar coordinate system.

5. The development system of claim 3, wherein the area segmentation tool allows a user to segment the circular-shaped user interface into the segmented areas with straight chords, curved chords, and slices.

6. The development system of claim 1, wherein the geometry tool provides primitive elements for placement in the non-rectangular user interface, including at least a rectangle element and an elliptical element.

7. The development system of claim 6, wherein the geometry tool allows a user to define an atom that automatically positions a first one of the primitive elements in a center position of the user interface with other ones of the primitive elements surrounding the first primitive element while respecting a parameterized gravitational pull and margin and anchoring definitions for the primitive elements.

8. The development system of claim 6, wherein the geometry tool allows a user to define edge anchors for anchoring the primitive elements within the non-rectangular user interface, including at least a North edge anchor, a South edge anchor, an East edge anchor, and a West edge anchor.

9. The development system of claim 6, wherein the geometry tool allows a user to specify a margin for each of the primitive elements, wherein the margin defines a minimum spacing between the primitive elements.

10. A method for developing a non-rectangular user interface, comprising:
segmenting, with an area segmentation tool, the non-rectangular user interface into segmented areas;
providing, with a geometry tool, primitive elements for placement in the segmented areas using a non-rectangular coordinate system;
converting, with the geometry tool, coordinates for the primitive elements from a rectangular coordinate system to the non-rectangular coordinate system; and
warping, with a content warping tool, the primitive elements to conform to the segmented areas of the non-rectangular user interface.

11. The method of claim 10, wherein the non-rectangular user interface is an elliptical-shaped user interface.

12. The method of claim 11, wherein the non-rectangular coordinate system is a polar coordinate system.

13. The method of claim 10, wherein the area segmentation tool allows a user to segment the non-rectangular user interface into the segmented areas with straight chords, curved chords, and slices.

14. A non-transitory computer-readable storage medium storing instructions that, when executed by at least one processor, cause the at least one processor to:
segment an elliptical user interface into segmented areas;
warp primitive user interface elements to conform to the segmented areas of the elliptical user interface;
convert coordinates for the primitive user interface elements from a rectangular coordinate system to a polar coordinate system; and
position the warped primitive user interface elements in the segmented areas using the polar coordinate system.

15. The non-transitory computer-readable storage medium of claim 14 storing instructions that, when executed by the at least one processor, further cause the at least one processor to:
anchor an edge of at least one of the primitive user interface elements to an edge of the elliptical user interface.
